(19) United States
(12) Patent Application Publication
(10) Pub. No.: US 2008/0107202 A1
(43) Pub. Date: May 8, 2008

(54) Multiple-input multiple-output communication system

(75) Inventors: Han-Lim Lee, Seoul (KR); Shuangfeng Han, Suwon-si (KR); Yun-Je Oh, Yongin-si (KR); Seong-Taek Hwang, Pyeongtaek-si (KR); Hoon Kim, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/906,370

(22) Filed: Oct. 2, 2007

(30) Foreign Application Priority Data
Nov. 7, 2006 (KR) 2006-109401

(51) Int. Cl. H04B 7/02

(52) U.S. Cl. 375/267

(57) ABSTRACT

A multiple-input multiple-output (MIMO) communication system includes a base station and a relay station that are connected through an optical fiber. The relay station wirelessly transmits through a plurality of antennas a signal received from the base station. The base station includes a plurality of symbol mappers for mapping input bit streams into a plurality of symbol signals; a MIMO multiplexer generating a plurality of exchange signals by exchanging bits of the symbol signals; and a plurality of code spreaders generating a plurality of spread signals by band spreading the exchange signals. The adoption of a wire transmission scheme for connecting the base station with the relay station through a single optical fiber provides benefits in cost reduction and complexity as the number of electrical-to-optical converters is reduced, and the bandwidth is superior to those in wireless transmission scheme

### CLAIM OF PRIORITY

This application claims the benefit under 35 U.S.C. §119(a) from an application entitled “Multiple-input Multiple-Output Communication System,” filed in the Korean Intellectual Property Office on Nov. 7, 2006 and assigned Serial No. 2006-109401, the contents of which are hereby incorporated by reference in its entirety.

### BACKGROUND OF THE INVENTION

1. Field of the Invention

The present invention relates to a wireless communication system. More particularly, the present invention relates to a multiple-input multiple-output (MIMO) communication system, which performs wireless communication using a plurality of antennas.

2. Description of the Related Art

With the continued increase in demand for high-speed data services from various users, the technological development of a physical layer capable of transmitting more data using limited communication resources is of the highest priority in order to provide users with more services at lower cost. Among the various techniques for improving transmission rates in the future, a MIMO technique, i.e. a technology that uses a plurality of antennas in a transmitter and receiver, is highly regarded as a method capable of making dramatic improvements in communication capacity, as well as transmission/reception performance, without the need for additional frequency allocation and electric power.

Due to the emergence of new communication systems, the trend towards higher carrier frequencies continues to move forward, and with it an increased demand for high-speed data services from users. The current communication systems also require more and more base stations due to minimization of cell size. As with the 4^{th} generation communications systems, systems aiming for data services at 1 Gb/s at rest, and 100 Mb/s in motion are expected to require many more base stations than in current use. However, the costs to install and maintain base stations are high, so it is quite difficult to provide a specific base station for each cell. Accordingly, demand is expected to increase for relay stations (RS) that connect with base stations and relay signals through an optical fiber. Methods for relaying signals from a base station to relay stations include wireless transmission and wire transmission. At the present time, transmission using wires is superior to wireless transmission in both reliability and bandwidth.

FIGS. 1 and 2 collectively illustrate a conventional MIMO communication system. The MIMO communication systems 100 and 200 include a base station 100 connected through a single optical fiber 180 (shown in FIG. 1) and a relay station 200 (shown in FIG. 2). The base station 100 transmits an optical signal to the relay station 200, and the relay station 200 engages in electrical-to-optical conversion for the optical signal S8, which has been received from the base station, to wirelessly transmits the converted signals into free space by using a plurality of antennas 240A through 240M.

Still referring to FIG. 1, the base station 100 includes a demultiplexer (DEMUX) 110, a plurality of encoders 120A through 120M, a plurality of symbol mappers 130A through 130M, a MIMO multiplexer (MIMO MUX) 140, a plurality of modulation parts 150A through 150M, a plurality of electrical-to-optical converters (E/O) 160A through 160M, and a first wavelength division multiplexer (WDM) 170. Here, M is a natural number.

The DEMUX 110 divides an input information bit stream Si into different bit streams S2_{A} through S2_{M} to output.

The encoders 120A through 120M receive the bit streams S2_{A} through S2_{M} serially from the DEMUX 110, and the respective encoders 120A through 120M encode the input corresponding bit streams S2_{A} through S2_{M} to output.

The symbol mappers 130A through 130M connect to the encoders 120A through 120M serially, and the respective symbol mappers 130A through 130M map input encoded bit streams S3_{A} through S3_{M} into symbol signals S4_{A} through S4_{M}. The symbol mapping is accomplished by grouping the encoded bit streams S3_{A} through S3_{M} to form a nonbinary symbol, and mapping the nonbinary symbol on a certain region of a constellation that corresponds to predetermined modulation schemes, such as binary phase shift keying (BPSK), quadrature phase shift keying (QPSK), and quadrature amplitude modulation, or the like. Here, the symbol signals S4_{A} through S4_{M}, which is output from the respective symbol mappers, 130A through 130M, are complex signals included with orthogonal I signals and Q signals. Further, the I signals and Q signals have structures with K parallel buses. Here, K is an arbitrary number of bits, such as 16 bits, 32 bits, 64 bits, 128 bits, etc.

The MIMO MUX 140 exchanges the bits of the symbol signals S4_{A} through S4_{M}, which are input from the symbol mappers 130A through 130M, in such a manner that the respective symbol signals S4_{A} through S4_{M} can be multi-transmitted via a plurality of antennas 240A through 240M, where M is a maximum number. By way of example, in a spatial data exchange process corresponding to two symbol signals, a first symbol signal S4_{A} includes the bits of {A₁, A₂, A₃, A₄, . . . , A_{N}}, which are arranged in time sequence, and a second symbol signal S4_{B}, includes the bits of {B₁, B₂, B₃, B₄, . . . , B_{N}}, the MIMO MUX 140 converts a first symbol signal S4_{A} into a first exchange signal S5_{A} with the bits of {A₁, B₂, A₃, B₄, . . . , A_{N}} for output, and converts the second symbol signal S4_{B} into a second exchange signal S5_{B} with signal elements of {B₁, A₂, B₃, A₄, . . . , B_{N}} for output.

The modulation parts 150A through 150M, which receive the exchange signals S5_{A} through S5_{M} serially from the MIMO MUX 140, and the respective modulation parts 150A through 150M, which perform an IQ modulation, i.e. an orthogonal modulation, on the input exchange signals S5_{A} through S5_{M}, and convert digital modulation signals into analog modulation signals S6_{A} through S6_{M} for output.

The electrical-to-optical converters 160A through 160M connect to the modulation parts 150A through 150M serially, and the respective electrical-to-optical converters 160A through 160M engage in electrical-to-optical conversion for the analog modulation signals S6_{A} through S6_{M}, which are inputted from the corresponding modulation part 150A through 150M, into optical signals S7_{A} through S7_{M} for output. Here, the optical signals S7A through S7M, which are output from the electrical-to-optical converters 160A through 160M have wavelengths that different from one another.

The WDM 170 wavelength-division multiplexes the optical signals S7_{A} through S7_{M}, which is input from the electrical-to-optical converters 160A through 160M, for output to the relay station 200 through the optical fiber 180.

Referring to FIG. 2, the relay station 200 includes a wavelength division demultiplexer (WDM) 210, a plurality of optical-to-electrical converters (O/E) 220A through 220M, a plurality of radio frequency (RF) transmitters (RF TXs) 230A through 230M, and a plurality of antennas 240A through 240M.

The WDM 210 wavelength-division demultiplexer will demultiplex the multiplexed optical signal S8, which was input from the relay station 100 through the optical fiber 180, for output. Thus, the conventional wavelength division multiplexer, such as an arrayed waveguide grating, has reversibility so that both wavelength division multiplexing and wavelength division demultiplexing can be performed. Accordingly, it is customary to indicate the wavelength division multiplexer and the wavelength division demultiplexer uniformly as WDM.

The optical-to-electrical converters 220A through 220M, which receive optical signals S9_{A} through S9_{M} serially from the WDM 210, and the respective optical-to-electrical converters 220A through 220M, engage in optical-to-electrical conversions for the input corresponding optical signals S9_{A} through S9_{M} into analog modulation signals S10_{A} through S10_{M} to output.

The RF TXs 230A through 230M, which connect to the optical-to-electrical converters 220A through 220M serially, and the respective RF TXs 230A through 230M, convert the analog modulation signals S10_{A} through S10_{M} input from the corresponding optical-to-electrical converters 220A through 220M into RF signals S11_{A} through S11_{M} with power and frequency suitable for wireless transmission to output.

The antennas 240A through 240M connect to the RF TXs 230A through 230M serially, and the respective antennas 240A through 240M wirelessly transmit the RF signals S11_{A} through S11_{M}, which are input from the corresponding RF TXs 230A through 230M, into free space.

However, the aforementioned MIMO communication system has a problem in that the number of costly electrical-to-optical converters and optical-to electrical converters will linearly increase with a corresponding increase in the number of MIMO channels, i.e. the number of antennas. In addition, the MIMO communication system should be provided with a wavelength division multiplexer and wavelength division demultiplexer, which are expensive, thereby causing a decrease in price competitiveness, and a lack of such WDMs will contribute to signal loss. Moreover, the MIMO communication system transmits optical signals with wavelengths different from one another, such that there should be a means provided for compensating wavelength distributions. However, providing such means will also complicate the structure of the systems.

### SUMMARY OF THE INVENTION

Accordingly, the present invention has been made in part to solve the above-mentioned problems occurring in the prior art. The present invention provides a MIMO communication system that increases price competitiveness when adopting a wire transmission scheme.

In accordance with an aspect of the present invention, there is provided a multi-input/multi-output communication system that includes a base station, and a relay station which is connected to the base station through an optical fiber, and wirelessly transmits signals inputted from the base stations through a plurality of antennas, wherein the base station includes: a plurality of symbol mappers mapping the input bit streams into a plurality of symbol signals; a multi-input/multi-output multiplexer generating a plurality of exchange signals by exchanging the bits of the symbol signals; and a plurality of code spreaders generating a plurality of spread signals by band spreading the exchange signals.

### BRIEF DESCRIPTION OF THE DRAWINGS

The above and other aspects, features and advantages of the present invention will be more apparent from the following detailed description taken in conjunction with the accompanying drawings, in which:

FIGS. 1 and 2 illustrate a conventional MIMO communication system.

FIGS. 3 and 4 illustrate a MIMO communication system according to a first embodiment of the present invention.

FIGS. 5 and 6 illustrate a MIMO communication system according to a second embodiment of the present invention.

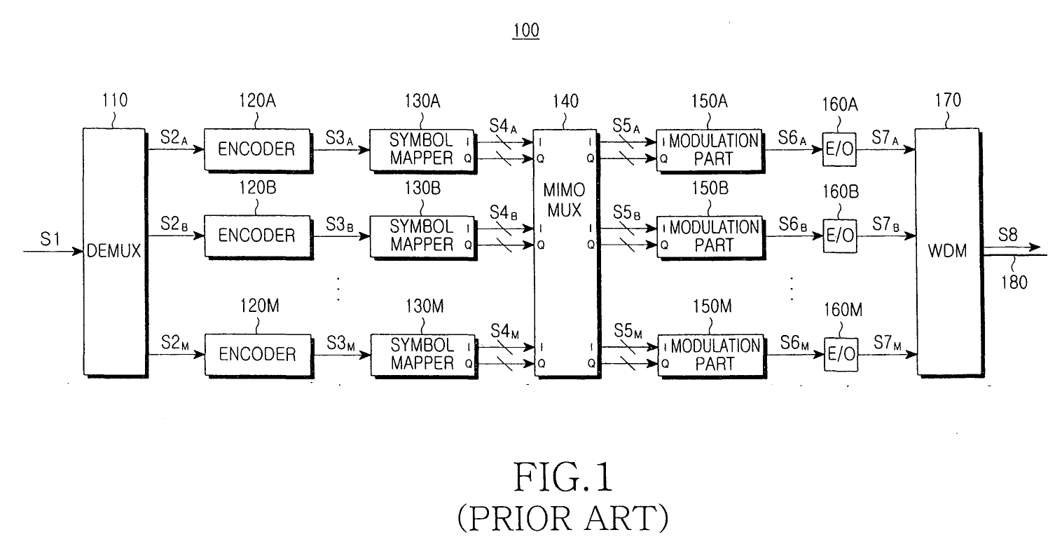

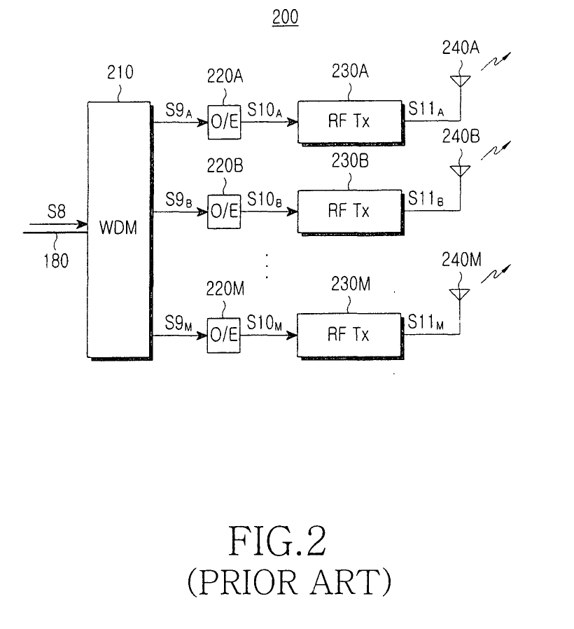

### DETAILED DESCRIPTION OF THE PRESENT INVENTION

Hereinafter, exemplary embodiments of the present invention will be described with reference to the accompanying drawings. It should be understood that the examples disclosed herein have been provided for purposes of illustration and not for limitation. Further, for the purposes of clarity and simplicity, a detailed description of known functions and configurations incorporated herein will be omitted so as not to obscure the subject matter of the present invention.

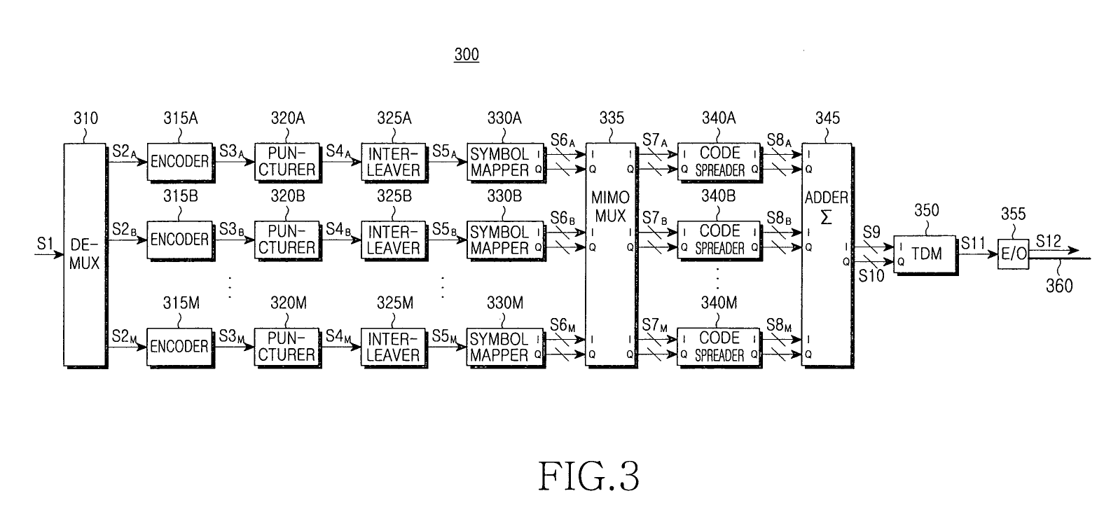

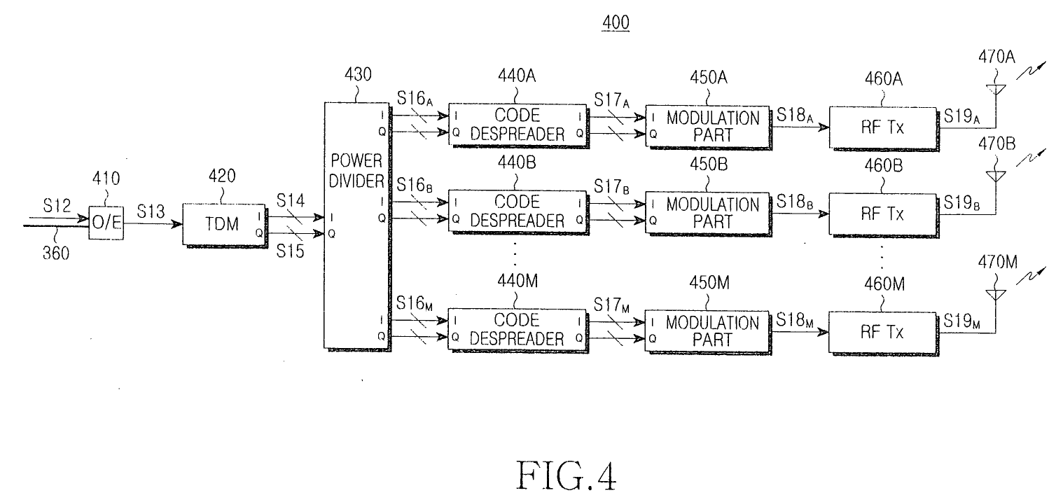

FIGS. 3 and 4 collectively illustrate a MIMO communication system according to a first exemplary embodiment of the present invention. The MIMO communication system (300 and 400) includes a base station 300 connected through an optical fiber 360, which is shown in FIG. 3, and a relay station 400, which is shown in FIG. 4. The base station 300 transmits an optical signal S12 to the relay station 400, and the relay station 400 engages in electrical-to-optical conversion for the optical signal S12 received from the base station 300 and wirelessly transmits the converted signal into free space using a plurality of antennas, 470A through 470M.

As shown in FIG. 3, the base station 300 typically includes a demultiplexer 310, a plurality of encoders 315A through 315M, a plurality of puncturers 320A through 320M, a plurality of interleavers 325A through 325M, a plurality of symbol mappers 330A through 330M, a MIMO multiplexer 335, a plurality of code spreaders 340A through 340M, an adder 345, a time division multiplexer (TDM) 350, and an electrical-to-optical converter 355.

The demultiplexer 310 divides an input bit stream S1 into individual bit streams S2_{A} through S2_{M} that are output to respective encoders 315A through 315M.

The encoders 315A through 315M respectively receive the bit streams S2_{A} through S2_{M} output from the demultiplexer 310, and the respective encoders 315A through 315M encode the inputted corresponding bit streams S2_{A} through S2_{M} for output. The encoding scheme is not limited to a particular scheme, and for example, can include a variety of different schemes of convolutional coding, such as low density parity check (LDPC) coding, cycle redundancy check (CRC) coding, turbo coding, block coding, or the like. The puncturers 320A through 320M connect to the encoders 315A through 315M serially, and the respective puncturers 320A through 320M delete the bit, which is satisfied with a predetermined condition, in encoded bit streams S3_{A} through S3_{M} inputted from the corresponding encoders 315A through 315M, thereby reducing coding overhead of the encoders 315A through 315M and controlling the encoding rate.

Still referring to FIG. 3, the interleavers 325A through 325M are connected to the puncturers 320A through 320M serially such that each respective interleaver 325A-325M receives a respective output from one of the puncturers 320A to 320M, and the respective interleavers 325A through 325M interleave the punctured bit streams S4_{A} through S4_{M} inputted from the corresponding puncturers 320A through 320M for output. The interleaving method performed is an error correction scheme, which typically inconsecutively disperses concentrically and consecutive bit errors that occur in predetermined parts of the bit streams. For example, in an interleaving process for an M punctured bit stream S4_{M}, when the M punctured bit stream S4_{M} is included with the bits of {A₁, A₂, . . . , A₉} arranged in time sequence, the M interleaver 325M outputs an M interleaving signal S5_{M} included with the bits of {A₁, A₄, A₇, A₂, A₅, A₈, A₃, A₆, A₉} obtained by interleaving the M punctured bit stream S4_{M}.

The symbol mappers 330A through 330M are connected to receive a respective output from one of the interleavers 325A through 325M serially. The respective symbol mappers 330A through 330M map the interleaved bit streams S5_{A} through S5_{M} received from the corresponding interleavers 325A through 325M into symbol signals S6_{A} through S6_{M}.

The symbol mapping can be accomplished by grouping the interleaved bit streams S5_{A} through S5_{M} to form a nonbinary symbol, and by mapping the nonbinary symbol on a certain region of a constellation that corresponds to predetermined modulation schemes, such as binary phase shift keying (BPSK), quadrature phase shift keying (QPSK), quadrature amplitude modulations, or the like. Here, symbol signals S6_{A} through S6_{M}, which are output from the respective symbol mappers 330A through 330M, are complex signals including orthogonal I signals and Q signals. Further, the I signals and Q signals have structures with K parallel buses. Here, K is an arbitrary number of bits, such as 16 bits, 32 bits, 64 bits, 128 bits, or the like.

As shown in FIG. 3, the MIMO multiplexer 335 exchanges the bits of the symbol signals S6_{A} through S6_{M} inputted from the symbol mapper 330A through 330M, in such a manner that the respective symbol signals S6_{A} through S6_{M} can be multi-transmitted through a plurality of antennas 470A through 470M (shown in FIG. 4), where M is a maximum number. For example, in a spatial data exchange process for two symbol signals, when a first symbol signal S6_{A} includes the bits of {A₁, A₂, A₃, A₄, . . . , A_{N}} arranged in time sequence and a second symbol signal S6_{B} includes the bits of {B₁, B₂, B₃, B₄, . . . , B_{N}} arranged in time sequence, the MIMO multiplexer 335 proceeds to convert the first symbol signal S6_{A} into a first exchange signal S7_{A} with the bits of {A₁, B₂, A₃, B₄, . . . , A_{N}} for output, and converts the second symbol signal S6_{B} into a second exchange signal S7_{B} with the bits of {B₁, A₂, B₃, A₄, . . . , B_{N}} for output.

The code spreaders, 340A through 340M, receive respective exchange signals S7_{A} through S7_{M} output from the MIMO multiplexer 335 serially, and the respective code spreaders 340A through 340M spread a band of the input corresponding to exchange signals S7_{A} through S7_{M}. The code spreaders 340A through 340M multiply the exchange signals S7_{A} through S7_{M} by spread codes with bit rates faster than those of the exchange signals S7_{A} through S7_{M}. The code spreaders 340A through 340M generate spread codes having orthogonality with one another, and also multiply each of the exchange signals S7_{A} through S7_{M} by a unique orthogonal spread code.

Still referring to FIG. 3, the adder 345 receives spread signals S8_{A} through S8_{M} from the code spreaders 340A through 340M, adds “I” signals of the spread signals S8_{A} through S8_{M} for output, and adds “Q” signals of the spread signals S8_{A} through S8_{M} for output.

The time division multiplexer (TDM) 350 time division multiplexes an added I signal S9 and added Q signal S10, which are both received from the output of adder 345, for output to an electrical-to-optical converter 355. The added I signal S9, and the added Q signal S10 have structures with each K parallel buses, and the time division multiplexer 350 converts the added I signal S9 and Q signal S10 serially, and time division multiplexes a serial I signal and a serial Q signal.

The electrical-to-optical converter 355 receives the signals output from the time division multiplexer 350, and performs an electrical-to-optical conversion for a time division multiplexed signal S11 inputted from the time division multiplexer 350 into an optical signal S12, and then outputs the optical signal S12 to the relay station 400 (shown in FIG. 4) through the optical fiber 360. The electrical-to-optical converter 355 may take many different forms, including but not limited to a Fabry-Perot laser, a distributed feedback laser, and a vertical cavity surface emitting laser (VCSEL), or the like.

As shown in FIG. 4, the relay station 400 includes an optical-to-electrical converter 410, a time division demultiplexer (TDM) 420, a power divider 430, a plurality of code despreaders 440A through 440M, a plurality of modulation parts 450A through 450M, a plurality of RF transmitters 460A through 460M, and a plurality of antennas 470A through 470M.

The optical-to-electrical converter 410 performs optical-to-electrical conversion for the optical signal S12 received from the base station 300 through the optical fiber 360 into a time division multiplexed signal S13 for output. The optical-to-electrical converter 410 may comprise a number a PIN photodiode, an avalanche photodiode (APD), or many other types of optical to electrical conversion devices.

The TDM 420 time division, which receives the electrical signal S13 from optical-to-electrical converter 410, then demultiplexes the time division multiplexed signal S13 into an added I signal S14 and Q signal S15 for output. It is customary in the art to indicate the time division multiplexer and the time division demultiplexer uniformly as a TDM.

The power divider 430 will output division signals S16_{A} through S16_{M} for code dispreading. The power divider 430 power divides the added I signal S14 and Q S15 signal input from the TDM 420 into N equal parts. The respective division signals S16_{A} through S16_{M} includes the added I signal and Q signal.

Still referring to FIG. 4, the code despreaders 440A through 440M receive the respective division signals S16_{A} through S16_{M} output from the power divider 430 serially, and restore exchange signals S17_{A} through S17_{M} from the division signals S16_{A} through S16_{M}, respectively. The code despreaders 440A through 440M restore the corresponding exchange signals S17_{A} through S17_{M} by multiplying input division signals S16_{A} through S16_{M} by the corresponding exchange signals S17_{A} through S17_{M} The modulation parts 450A through 450M connect to the respective code despreaders 440A through 440M serially, and the respective modulation parts 450A through 450M engage in IQ modulations, i.e. orthogonal modulations, for the input corresponding exchange signals S17_{A} through S17_{M} and convert digital modulation signals into analog modulation signals S18_{A} through S18_{M} to output. The respective modulation parts 450A through 450M can be implemented by a single chip or composition of conventional IQ modulator and digital-to-analog (D/A) converter.

The RF transmitters 460A through 460M receive the modulated output of modulation parts 450A through 450M serially, and the respective RF transmitters 460A through 460M convert the analog modulated signals S18_{A} through S18_{M} received from the corresponding modulators 450A through 450M into RF signals S19_{A} through S19_{M} with power and frequency suitable for wireless transmission to output.

The antennas 470A through 470M receive the output for transmission from the RF transmitters 460A through 460M serially, and the respective antennas 470A through 470M wirelessly transmit the RF signals S19_{A} through S19_{M} received from the corresponding RF transmitters 460A through 460M into free space.

In the above-described first exemplary embodiment of the present invention, digital baseband (BB) signals are transmitted through the optical fiber 360 SO that it is generally required for the time division multiplexer (TDM) 350 to operate at high speeds.

Hereinafter, the configuration of transmitting an analog intermediate frequency (IF) through optical fiber will be described in a secondary exemplary embodiment of the present invention.

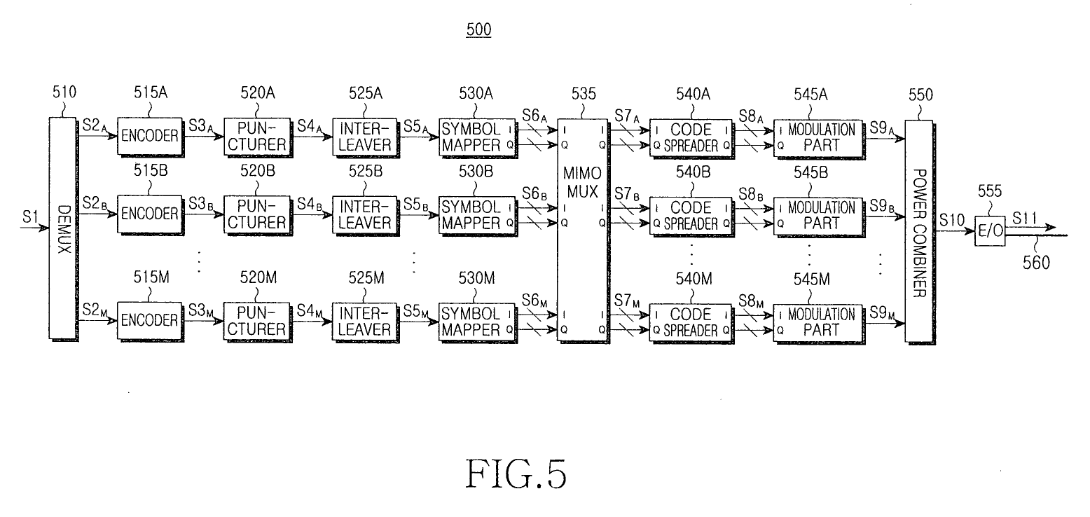

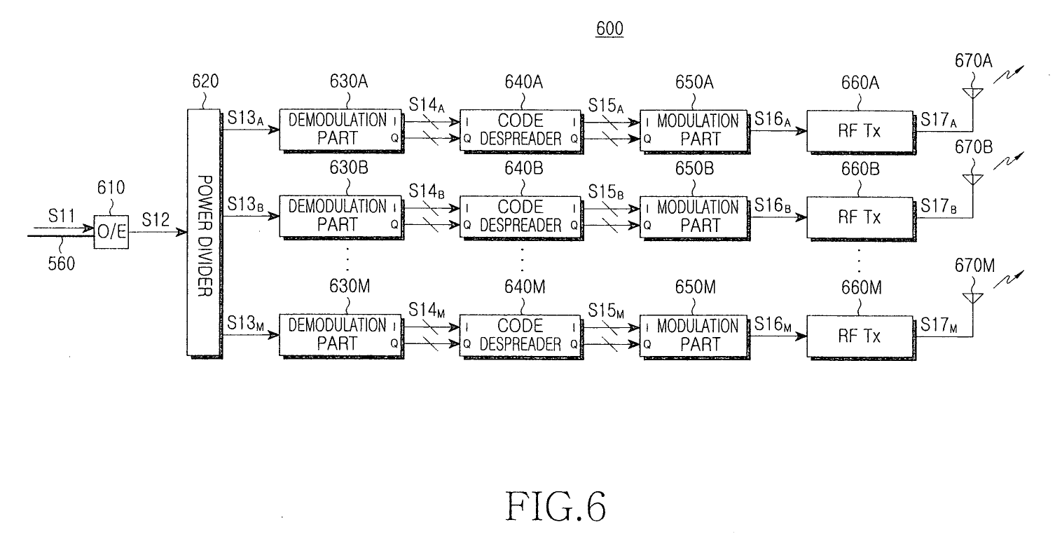

FIGS. 5 and 6 illustrate a MIMO communication system according to a second exemplary embodiment of the present invention. The MIMO communication system 500 (shown in FIG. 5) and 600 (shown in FIG. 6) includes a base station 500 connected through an optical fiber 560, and a relay station 600. The base station 500 transmits an optical signal S11 to the relay station 600, and the relay station 600 performs electrical-to-optical conversion for the optical signal S11 received from the base station 500 and wirelessly transmits the converted signal into free space using a plurality of antennas 670A through 670M. The MIMO communication system 500 and 600 has configurations similar to those of shown in FIGS. 3 and 4, and thus repetitive descriptions will be avoided as necessary.

The base station 500 includes a demultiplexer 510, a plurality of encoders 515A through 515M, a plurality of puncturers 520A through 520M, a plurality of interleavers 525A through 525M, a plurality of symbol mappers 530A through 530M, a MIMO multiplexer 535, a plurality of code spreaders 540A through 540M, a plurality of modulation parts 545A through 545M, a power combiner 550, and an electrical-to-optical converter 555, all of which are generally connected consecutively.

The demultiplexer 510 demultiplexes an input information bit stream S1 into a plurality of individual bit streams S2_{A} through S2_{M} for output.

The encoders 515A through 515M respectively receive the plurality of bit streams S2_{A} through S2_{M} serially from the demultiplexer 510, and the respective encoders 515A through 515A then encode the input corresponding bit streams S2_{A} through S2_{M} for output.

The puncturers 520A through 520M respectively receive the output from encoders 515A through 515M serially, the respective puncturers 520A through 520M delete the bit satisfying a predetermined condition in the encoded bit streams S3_{A} through S3_{M} input from the corresponding encoders 515A through 515M, thereby reducing the coding overhead of the encoders 515A through 515M and controlling an encoding rate.

Still referring to FIG. 5, the interleavers 525A through 525M respectively receive the output from the puncturers 520A through 520M serially, and the respective interleavers 525A through 525M interleave the punctured bit streams S4_{A} through S4_{M} input from the corresponding puncturers 520A through 520M to output.

The symbol mappers 530A through 530M respectively receive the output from the interleavers 525A through 525M serially, and the respective symbol mappers 530A through 530M map interleaved bit streams S5_{A} through S5_{M} input from the corresponding interleavers 525A through 525M into symbol signals S6_{A} through S6_{M}. Here, the symbol signals S6_{A} through S6_{M} output from the respective symbol mappers 530A through 530M are complex signals including I signals and Q signals. Further, the I signals and Q signals have structures with K parallel buses.

The MIMO multiplexer 535 exchanges the bits of the symbol signals S6_{A} through S6_{M} output from the symbol mappers 530A through 530M, such that the respective symbol signals S6_{A} through S6_{M} can be transmitted through a plurality of antennas 670A through 670M, where M is a maximum number.

The code spreaders 540A through 540M respectively receive exchange signals S7_{A} through S7_{M} output from the MIMO multiplexer 535 serially, the respective code spreaders 540A through 540M spread the bands of the input corresponding exchange signals S7_{A} through S7_{M} to output. The code spreaders 540A through 540M multiply the exchange signals S7_{A} through S7_{M} by spread codes with bit rates faster than those of the exchange signals S7_{A} through S7_{M}. The code spreaders 540A through 540M generate spread codes having orthogonality with one another, and multiply each exchange signals S7_{A} through S7_{M} by a unique orthogonal spread code.

Continuing to refer to FIG. 5, the modulation parts 545A through 545M respectively receive the output from the code spreaders 540A through 540M serially, and the respective modulation parts 545A through 545M perform IQ modulations of the corresponding spread signals S8_{A} through S8_{M}, that are input respectively to the modulations parts 545A to 545M and convert the digital modulation signals into analog modulation signals S9_{A} through S9_{M} for output. The analog modulation signals S9_{A} through S9_{M} output from the respective modulation parts 545A through 545M have an intermediate frequency.

The power combiner 550 receives the respective analog modulation signals S9_{A} through S9_{M} from the modulation parts 545A through 545M and combines the analog modulation signals S9_{A} through S9_{M} for output. If the analog modulation signals S9_{A} through S9_{M} have intermediate frequencies different from one another, a conventional frequency multiplexer can then be used as the power combiner 550.

The electrical-to-optical converter 555 connects to the power combiner 550. The electrical-to-optical converter 555 performs in electrical-to-optical conversion for the combined signal S10 input from the power combiner 550 into an optical signal S11 and outputs the optical signal S11 to the relay station 600 through the optical fiber 560.

Referring to FIG. 6, the relay station 600 includes a plurality of demodulation parts 630A through 630M a plurality of code despreaders 640A through 640M, which are in communication with the demodulation parts, respectively, a plurality of modulation parts 650A through 650M, which are in communication with despreaders, respectively, a plurality of RF transmitters 660A through 660M, which are in communication with the modulation parts, respectively, and a plurality of antennas 670A through 670M.

The optical-to-electrical converter 610 performs optical-to-electrical conversion for the optical signal S11 that is received from the base station 500 via optical fiber 560 into a combined signal S12 to output.

Still referring to FIG. 6, the power divider 620 power divides the combined signals S12 that are received from the optical-to-electrical converter 310, and outputs a plurality of division signals S13_{A} through S13_{M} into N equal parts.

The demodulation parts 630A through 630M respectively receive and demodulate the division signals S13_{A} through S13_{M} from the power divider 620. The demodulation parts 630A through 630M respectively output spread signals S14_{A} through S14_{M}. The respective demodulation parts 630A through 630M convert the input division signals S13_{A} through S13_{M} into digital signals, and demodulate the digital spread signals S14_{A} through S14_{M} from the digital division signals. The respective spread signals S14_{A} through S14_{M} include I signals and Q signals. The respective demodulation parts 630A through 630M can be implemented by a single chip, or a combination of a conventional analog-to-digital (A/D) converter and IQ demodulator.

The code despreaders 640A through 640M, which are respectively connected to the demodulation parts 630A through 630M, receive spread signals S14_{A} through S14_{M} from the demodulation parts 630A through 630M, respectively, and restore the exchange signals S15_{A} through S15_{M} from the spread signals S14_{A} through S14_{M}, which are output to the modulation parts 650A through 650M, respectively. The code despreaders 640A through 640M restore the corresponding exchange signals S15_{A} through S15_{M} by multiplying input spread signals S14_{A} through S14_{M} by the corresponding spread codes.

The modulation parts 650A through 650M are coupled to the code despreaders 640A through 640M so as to respectively receive the outputs from the code despreaders, and the respective modulation parts 650A through 650M perform IQ modulations for the input corresponding exchange signals S15_{A} through S15_{M}, and convert digital modulation signals into analog modulation signals S16_{A} through S16_{M} for output. The analog modulation signals S16_{A} through S16_{M} that are output from the respective modulation parts 650A through 650M have an intermediate frequency.

Still referring to FIG. 6, the RF transmitters 660A through 660M respectively receive the outputs of the modulation parts 650A through 650M, and each of the respective RF transmitters 660A through 660M convert the respective analog modulation signals S16_{A} through S16_{M} input from the corresponding modulation part 650A through 650M into one of RF signals S17_{A} through S17_{M} with power and frequency suitable for a wireless transmission output.

The antennas 670A through 670M respectively receive the output from the RF transmitters 660A through 660M, and the respective antennas 670A through 670M wirelessly transmit the RF signals S17_{A} through S17_{M} into free space.

As described above, the MIMO communication system according to the present invention has many advantages, some of which are:

The adoption of a wire transmission scheme for connecting the base station with the relay station through a single optical fiber in a manner typically exemplified above that the expenses for installation of transmission lines and administrative and maintenance expenses are reduced dramatically, and the reliability and the bandwidth is superior to those in wireless transmission scheme; and

Unlike systems in the prior art, wherein the electrical-to-optical converters and the optical-to-electrical converters are provided in an amount corresponding to the number of MIMO channels as a requirement because of the adoption of wavelength division multiplexing scheme, the present invention does not require a corresponding or equivalent amount of converters to MIMO channels. One reason is that the present invention adopts a code spread scheme and code despread scheme, i.e. code division multiplexing (CDM) scheme, so that only one electrical-to-optical converter and optical-to-electrical converter are required, and costly wavelength division multiplexer and wavelength division demultiplexer are not necessary, thereby increasing price competitiveness.

While the invention has been shown and described with reference to certain exemplary embodiments thereof, which were provided for purposes of illustration, it will be understood by those skilled in the art that various changes in form and details may be made therein without departing from the spirit and scope of the invention as defined by the appended claims.

What is claimed is:

1. A multiple-input multiple-output (MIMO) communication system comprising a base station and a relay station that are connected through an optical fiber, said MIMO communication system wirelessly transmitting through a plurality of antennas at the relay station a signal received from the base station, wherein the base station comprises:
a plurality of symbol mappers mapping input bit streams into respective symbol signals;
a MIMO multiplexer for generating a plurality of respective exchange signals by exchanging bits of the respective symbol signals; and
a plurality of code spreaders for generating a plurality of spread signals by band spreading the exchange signals.

2. The MIMO communication system as recited in claim 1, wherein the base station further comprises:
a demultiplexer for dividing an input information bit stream into a plurality of respective bit streams; and
a plurality of encoders for encoding the plurality of respective bit streams for output to the plurality of symbol mappers, respectively.

3. The MIMO communication system as recited in claim 2, wherein the base station further comprises:
a plurality of puncturers for puncturing encoded bit streams respectively received from the plurality of encoders; and
a plurality of interleavers for interleaving punctured bit streams respectively received from the puncturers, said plurality of interleavers outputting the interleaved punctured bit streams to the symbol mappers, respectively.

4. The MIMO communication system as recited in claim 1, wherein the base station further comprises:
an adder for adding I signals and Q signals included in the plurality of spread signals, respectively;
a time division multiplexer (TDM) for time division multiplexing added I signals and Q signals received from the adder; and
an electrical-to-optical converter for performing electrical-to-optical conversion of a time division multiplexed signal received from the TDM into an optical signal for transmission to the relay station through the optical fiber.

5. The MIMO communication system as recited in claim 1, wherein the base station further comprises:
a plurality of modulation parts for IQ modulating the plurality of spread signals;
a power combiner for combining the plurality of modulated signals respectively output from the modulation parts; and
an electrical-to-optical converter for performing electrical-to-optical conversion of combined electrical signals output from the power combiner into an optical signal for transmission to the relay station through the optical fiber.

6. The MIMO communication system as recited in claim 1, wherein the relay station comprises:
a plurality of code despreaders for restoring the exchange signals from a plurality of spread signals received from the base station; and
a plurality of modulation parts for IQ modulating the exchange signals output from the code despreaders.

7. The MIMO communication system as recited in claim 6, wherein the relay station further comprises;
a plurality of radio frequency (RF) transmitters for converting the plurality of modulation signals received from the modulation parts into respective RF signals for wireless transmission; and
a plurality of antennas for wirelessly transmitting the RF signals output from the RF transmitters into free space.

8. The MIMO communication system as recited in claim 4, wherein the relay station comprises:
an optical-to-electrical converter for performing optical-to-electrical conversion of an optical signal received from the base station through the optical fiber into a time division multiplexed signal;
a time division demultiplexer for time division demultiplexing the time division multiplexed signal received from the optical-to-electrical converter into the added I signal and added Q signal;
a power divider for power dividing the added I signal and Q signal received from the time division demultiplexer to generate a plurality of division signals;
a plurality of code despreaders for restoring the exchange signals from the division signals received from the power divider; and
a plurality of modulation parts for IQ modulating the exchange signals received from the code despreaders.

9. The MIMO communication system as recited in claim 8, wherein the relay station further comprises:
a plurality of RF transmitters for converting the plurality of modulation signals received from the modulation parts into a plurality of respective RF signals for wirelessly transmission; and
a plurality of antennas for wirelessly transmitting into free space the plurality of respective RF signals received from the respective plurality of RF transmitters.

10. The MIMO communication system as recited in claim 5, wherein the relay station comprises:
an optical-to-electrical converter for performing optical-to-electrical conversion of the optical signal received from the base station through the optical fiber into the combined signal;
a power divider for power dividing the combined signal received from the optical-to-electrical converter to generate a plurality of division signals;
a plurality of demodulation parts for demodulating the spread signals from the division signals received from the power divider;
a plurality of code despreaders for restoring the exchange signals from the division signals received from the plurality of demodulation parts; and
a plurality of modulation parts for IQ modulating the respective exchange signals output from the code despreaders.

11. The MIMO communication system as recited in claim 10, wherein the relay station further comprises:
a plurality of RF transmitters for converting the respective modulation signals received from the plurality of modulation parts into RF signals for wireless transmission; and
a plurality of antennas for transmitting into free space the RF signals received from the plurality of RF transmitters.

12. A method for multiple-input multiple-output (MIMO) communication system having a base station and a relay station that are connected through a single optical fiber, said MIMO communication system wirelessly transmitting through a plurality of antennas at the relay station a signal received from the base station, wherein the method of transmission at the base station to the relay station includes the following steps:
demultiplexing an input signal into a plurality of respective bit streams;
encoding the plurality of respective bit streams;
mapping the plurality of respective input bit streams into respective symbol signals;
generating a plurality of respective exchange signals by exchanging bits of the respective symbol signals;
generating a plurality of spread signals by band spreading the exchange signals;
adding I signals and Q signals included in the plurality of spread signals, respectively;
multiplexing the added I signals and Q signals; and
converting the multiplexed electrical signal into an optical signal for transmission to the relay station through the single optical fiber.

13. A method for multiple-input multiple-output (MIMO) communication system having a base station and a relay station that are connected through a single optical fiber, said MIMO communication system wirelessly transmitting through a plurality of antennas at the relay station a signal received from the base station, wherein the method of wireless transmission by the relay station of the signal received from the base station via the optical fiber includes the following steps:
restoring with a plurality of code despreaders a plurality of exchange signals from a plurality of spread signals received from the base station;
IQ modulating the exchange signals output from the code despreaders into a plurality of respective modulated signals;
converting the plurality of modulated signals into respective RF signals for wireless transmission; and
wirelessly transmitting into free space the output RF signals.
